(19) United States
(12) Patent Application Publication
(10) Pub. No.: US 2013/0278424 A1
(43) Pub. Date: Oct. 24, 2013

(54) Asset Identification And Messaging System And Method

(71) Applicant: MYOWNER.COM, LLC, Chaska, MN (US)

(72) Inventor: Norman E. Knowles, Chaska, MN (US)

(73) Assignee: myowner.com, LLC, Chaska, MN (US)

(21) Appl. No.: 13/865,887

(22) Filed: Apr. 18, 2013

Related U.S. Application Data
(60) Provisional application No. 61/625,958, filed on Apr. 18, 2012.

(51) Int. Cl. G08B 13/24

(52) U.S. Cl. CPC G08B 13/2462
USPC 340/572.1

(57) ABSTRACT

An asset identification and messaging system and method to provide a unique, confidential, asset identification system, where the identification is tied to a unique alphanumeric and unique image. People who find the asset can report it found by entering the unique alphanumeric at a website or by using an image scanning application which notifies the owner and opens a web page to collect contact information from the user which is then passed to the owner. The asset identification and messaging system and method generally includes the use of Unique Alphanumeric Asset Id's, Unique Image Id's, a confidential Asset database where the owners identity is not known, and a submission and notification system.

### CROSS-REFERENCE TO RELATED APPLICATIONS

This utility application claims priority from provisional application No. 61/625,958 filed Apr. 18, 2012.

### STATEMENT REGARDING FEDERALLY SPONSORED RESEARCH

Not Applicable

### FIELD OF THE INVENTION

The present invention relates generally to myowner labels and more specifically it relates to an asset identification and messaging system and method.

### BACKGROUND OF THE INVENTION

The purpose of my invention is to provide a unique, confidential, asset identification system, where the identification is tied to a unique alphanumeric and unique image. People who find the asset can report it found by entering the unique alphanumeric at a website or by using an image scanning application which notifies the owner and opens a web page to collect contact information from the user which is then passed to the owner.

### BRIEF SUMMARY OF THE INVENTION

The invention generally relates to a myowner label which includes a unique identification, which can be used to recover lost property. The main elements of my invention include the use of Unique Alphanumeric Asset Id's, Unique Image Id's, a confidential Asset database where the owners identity is not known, and a submission and notification system.

Because the image uses a Bar Code, QR or Quick Response Code, Microsoft TAG, or other unique image, no power is required, so the system works when the power is off. It is easy to notify the owner of found assets, a one step QR code based notification process is disclosed. The system provides the ability to search for the owner even if the tag is removed (using information associated with the asset registered against the unique identification). The tags or labels can also be transferrable—sell an asset to someone else and the new owner can register it.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

An object is to provide an asset identification and messaging system and method to provide a unique, confidential, asset identification system, where the identification is tied to a unique alphanumeric and unique image. People who find the asset can report it found by entering the unique alphanumeric at a website or by using an image scanning application which notifies the owner and opens a web page to collect contact information from the user which is then passed to the owner.

Another object is to provide an Asset Identification And Messaging System And Method that provide an asset identification and messaging system and method that provides a means to assign a unique identification character string to a unique item where the identity of the asset owner is not known.

Another object is to provide an Asset Identification And Messaging System And Method that provide an asset identification and messaging system and method that includes a database of assets which includes a unique identification string for each asset item, a series of fields which describe the unique features of the item, and which are associated with a unique account ID.

Another object is to provide an Asset Identification And Messaging System And Method that provide an asset identification and messaging system and method that includes a messaging service where images can be scanned by a mobile phone application which retrieves an associated URL and Identification string which are used to open a web page where the unique Identification string is passed to the web page which causes a message to be generated to the account owner via multiple registered communication vehicles.

Another object is to provide an Asset Identification And Messaging System And Method that provide an asset identification and messaging system and method that causes a web page to be created and generated on the mobile device of a user who has scanned a QR code which confirms the description of the item and provides a means by which the user may send their contact information to the account owner.

Another object is to provide an Asset Identification And Messaging System And Method that provide an asset identification and messaging system and method that includes provides for multiple means by which to adhere the unique item identification string to the item. Identification strings may be adhered with a paper, plastic, or metal label which is affixed to the device with an adhesive glue; or may be printed directly on the item, or may be engraved in the item, or may be painted on the item.

Another object is to provide an Asset Identification And Messaging System And Method that provide an asset identification and messaging system and method that does not know the identity of the account owner.

Other objects and advantages of the present invention will become obvious to the reader and it is intended that these objects and advantages are within the scope of the present invention. To the accomplishment of the above and related objects, this invention may be embodied in the form illustrated in the accompanying drawings, attention being called to the fact, however, that the drawings are illustrative only, and that changes may be made in the specific construction illustrated and described within the scope of this application.

### BRIEF DESCRIPTION OF THE DRAWINGS

FIG. 1 is a flowchart illustrating the overall operation of the present invention. Flowchart of the Asset ID Generation and Asset ID Image Generation processes.

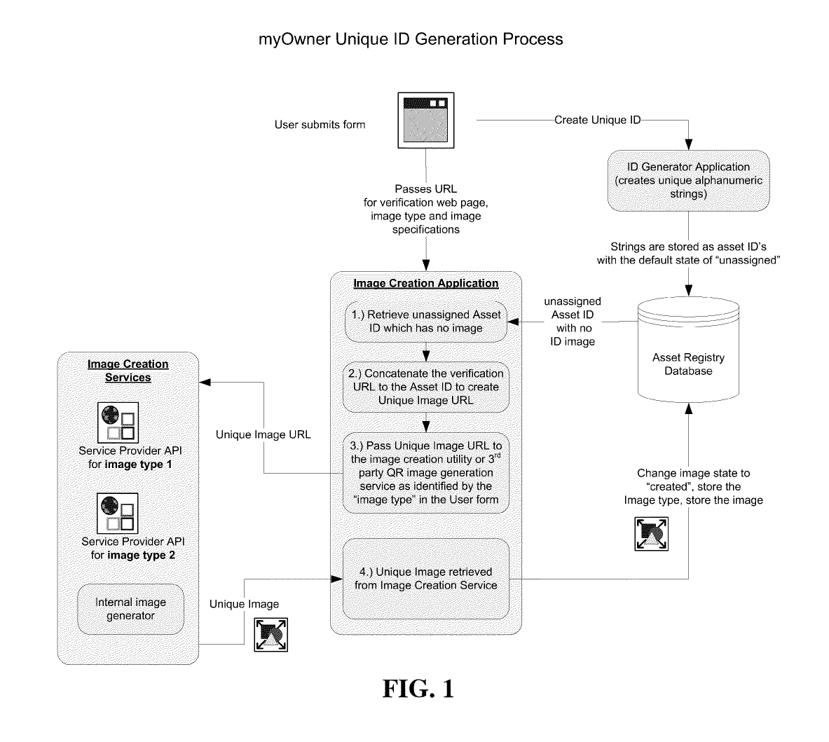

FIG. 2 is a flowchart illustrating the overall operation of the present invention. Flowchart of the process to extract unique Asset ID's and related Asset ID images.

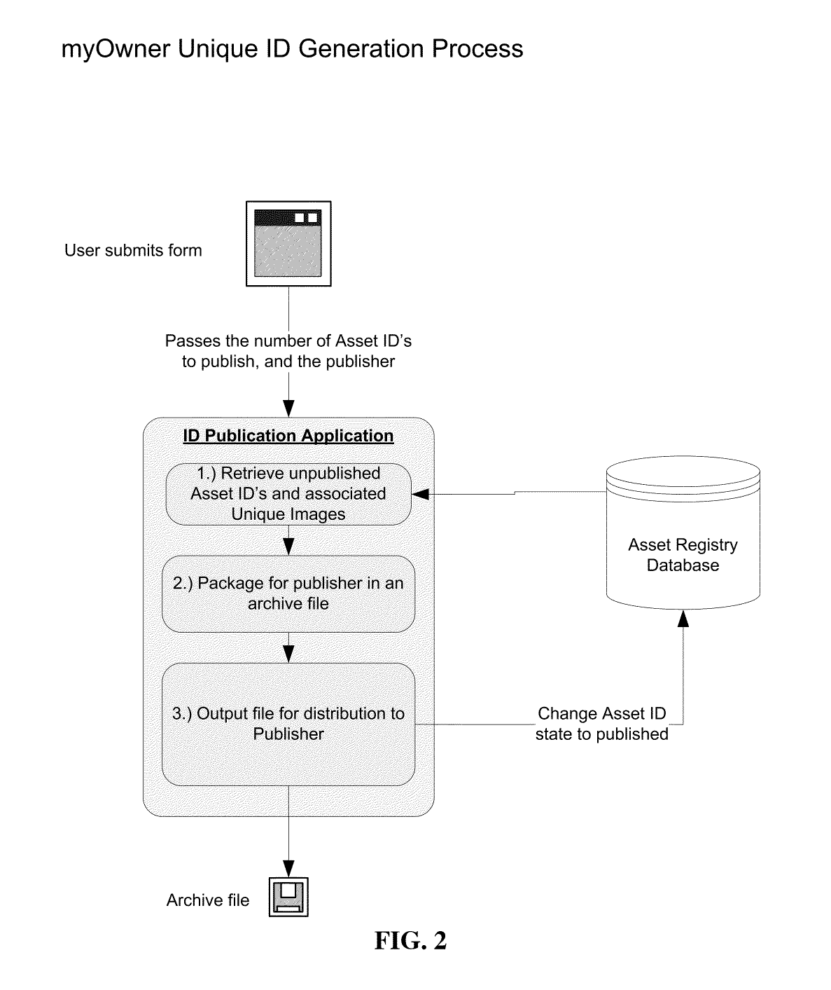

FIG. 3 is a flowchart illustrating the overall operation of the present invention. Flowchart which described the flow of information from Asset ID submission via multiple methods to the notification of Asset owners.

FIG. 4 shows an exemplary tag or label.

### DETAILED DESCRIPTION OF THE INVENTION

While this invention may be embodied in many forms, there are described in detail herein specific embodiments of the invention. This description is an exemplification of the principles of the invention and is not intended to limit the invention to the particular embodiments illustrated.

For the purposes of this disclosure, like reference numerals in the figures shall refer to like features unless otherwise indicated.

### A. Overview

Turning now descriptively to the drawings, in which similar reference characters denote similar elements throughout the several views, the figures illustrate The main elements of my invention include the use of Unique Alphanumeric Asset Id's, Unique Image Id's, a confidential Asset database where the owners identity is not known, and a submission and notification system.

There are two parts to the overall system and method: 1) Tag it and 2) Return it. These general steps are set forth in more detail below:

Tag It:

1. Create a confidential account with contact information (email, text number, etc.).

2. Tag asset by applying a tag to it.

3. Register the myOwner ID for the asset in the myOwner encypted database account.

Return It:

1. Find item. Finder either scans the ID tag or enters the ID# at myOwner.com.

2. Notify. myOwner will automatically notify you at all the contacts in your profile.

3. Return. The owner contacts the finder to coordinate return of the asset.

### B. Unique Alphanumeric Asset Identification Strings

The Unique Asset Identifications strings structure is comprised of a string of characters of undetermined length which includes random numbers and letters which are stored in a central database. Each character string shall be unique in the database and never duplicated. The function of the Unique Asset Identification String is to provide a unique identification structure that can be added to any item and make it easy to identify each unique item. The Unique Asset Identification string is connected to the Unique Image ID as it is included in the URL string that is used to define the image structure. The Unique Asset ID is stored in the Confidential Asset Database. The Unique Asset ID may be used to identify the registered asset to which it is linked and facilitate notification to the account owner through the Submission and Notification System.

The Unique Alphanumeric Asset Identification string is a unique string of characters which may include alphabetic, numeric, and symbols. Each Alpha Numeric Character string 11 is unique and not duplicated.

Unique Alphanumeric Asset Identification string may include all alphabetic characters, all numeric characters, all symbols, or may include a mix of alphabetic characters, numeric characters, and or symbols.

### C. Unique Image

The structure of the Unique Image is Bar Code, QR or Quick Response Code, Microsoft TAG, or other unique image which is associated with a defined URL and a Unique Alphanumeric Asset Identification string. The function of the Unique Image is to provide an object that can be interpreted by a scanner which can then obtain the associated URL and Unique Alphanumeric Asset Identification string. The process of scanning the image results in the opening of an internet page associated with the URL and the Unique Alphanumeric Asset Identification string is passed with the URL to the server hosting the web page in order to perform a search on the page.

The Unique Image may be comprised of colors 21 and shapes 23 which are layered out to form an image. The combination of color 21 and shapes 23 creates a unique image. The Unique Image is associated with a URL 24 which provides an address to a Internet web page for the Server Application 84.

The image can be printed in multiple sizes and shapes 23 with all colors 21 available in the color spectrum.

However, it should be understood that the unique ID may be numeric, alphanumeric, color coded or black and white. All that is important is that the unique ID be printed on the tag (or label) and registered in the database against the owner contact information.

### D. Registry

The Registry structure is comprised of a database which contain user registration and contact information and a database which contains information regarding individual registered items which includes the Unique Alphanumeric Asset ID, the Registered Users ID, product name, model number, serial number, color, and other descriptive data fields. The function of the Registry is to provide a database of what items are associated with which Unique Alphanumeric Asset ID's, and what Unique Alphanumeric Asset ID's are associated with which Registered User D's.

The Registry is a database 31 of elements with multiple tables and data elements. The database is used to organize the Unique Alphanumeric Asset Identification Strings 10 where they are stored in a Unique Alphanumeric Asset Identification String Field 32 which are then stored in the same row of the same table with the Registered User ID field 33, the Model Number Field 34, and the Serial Number Field 35 as well as other descriptive fields 36.

The database can be constructed of multiple linked or individual tables which may be accessed through multiple communication constructs.

### E. Notification Service

The Notification Service structure is comprised of a database of contact information which is associated with each Registered User ID and multiple systems for generating messages through such systems, which include phone, email, text message or any other electronic messaging system. The function of the Notification Service is to upon identification of a Unique Alphanumeric Asset Identification string being reported by a User as found, the notification system will retrieve the contact information for the Registered User ID associated with the Unique Alphanumeric Asset Identification string and pass contact information to the Registered User from the User.

When a User of a HTML Internet Page 44, which identifies a specific Unique Alphanumeric Asset Identification String 10, on either a computer or a mobile device selects enters a message into the Message field 45 and a contact number into the Contact Field 46 and selects the submit button, the notification system retrieves the Contact information from the Registered User ID 60 that is associated with the Unique Alphanumeric Asset Identification String 10 and generates a Message 45 to the Registered User's contact numbers which includes the information from the Message Field 45 and the Finder Contact Field 46.

The service may communicate the messages through any communication System 43, which includes but is not limited to Phone, email, Text Message, Facebook Service, and Twitter Service.

### F. Identification Label

The Identification label is comprised of substrate on which is printed the Unique Alphanumeric Asset Identification string and/or the Unique Image and URL. The Identification label includes an adhesive on one side which allows it to be secured to the item to which it will be associated. The function of the Identification Label is to provide the item with a unique identification.

The identification label is a vehicle to communicate to the finder of an item, the identity of the item by way of the Unique Alphanumeric Asset Identification String 10 and/or a Unique Image. The identification label includes an Internet URL 57 which advises the User as to how to report the item as found. The label can be manufactured out of any substrate and the Unique Image 20 and or the Unique Alphanumeric Asset Identification String 10 are printed on the substrate. Once printed on the substrate, the printed items are covered with a clear wear layer 53 to protect the printing from wearing off. On the reverse side of the Identification Label 50, Adhesive 52 is applied which is used to secure the Identification Label 50 to an Item.

The Identification Label can be created in any color and on any substrate or may be printed directly on an Item.

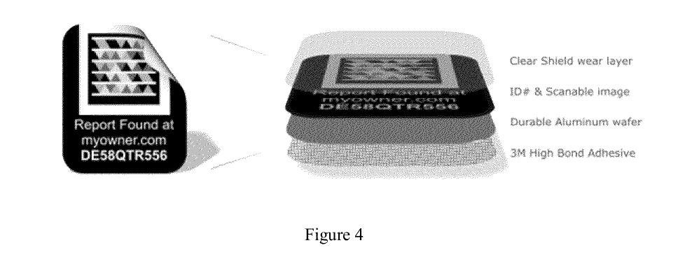

An exemplary tag or label is shown in FIG. 4. The exemplary tag uses Microsoft TAG to store the unique identification in machine readable form, such as by imaging the tag using a smartphone application, as well as displaying the identification (DE58QTR556 in the example) in human readable form, along with the website address myowner.com to report the found item or asset to. The tag is comprised of a durable aluminum wafer with the ID# and scanable image printed on top, and covered by a clear shield wear layer. The bottom of the wafer contains high bond adhesive. The label is peeled from its release layer and placed on the asset to be identified.

### G. Registered User Id

The Registered User ID structure is a unique character string which is assigned to each Registered User upon account creation. The Registered User ID is associated with the contact information for the Registered User and multiple Unique Alphanumeric Asset Identification strings.

The Registered User ID 60 is a unique string of characters which may include alphabetic, numeric, and symbols. Each Registered User ID 60 is unique and not duplicated.

The Registered User ID may include all alphabetic characters, all numeric characters, all symbols, or may include a mix of alphabetic characters, numeric characters, and or symbols.

### H. Internet Accessing Device

The Internet Accessing device may be a computer, a tablet, a mobile device or other device which has access to display and interact with Internet hosted web pages. The function of this device is to provide the ability to either 1.) Scan the unique image and pass it to a server over the Internet or 2.) Provide an Internet hosted web page which includes a form which may be used to enter a Unique Alphanumeric Asset Identification String which is then submitted to the server.

The Internet Accessing Device can be any device which is capable of accessing and interacting with web pages via the Internet or a public or private network.

The Internet Access Device may be a computer, a network terminal, a cell phone, a smartphone, a tablet, or any other device which is capable of accessing and interacting with a server over the Internet or any public or private network. The device may include an optional scanning device or a camera which is used to scan images.

### I. Server

The server is a piece of equipment which is used to host the Registry 30 application and the Unique Alphanumeric Asset Identification String Database 31. The server is also used to host the Notification Service 40 application.

The Server 80 is a piece of computer equipment, the Server Hardware 81, which is controlled by a software operating system 83 and is connected to a network connection 82 and or the Internet.

The server can be hosted in the Internet Cloud, or may be operated as a dedicated Server.

### J. Connections of Main Elements and Sub Elements of Invention

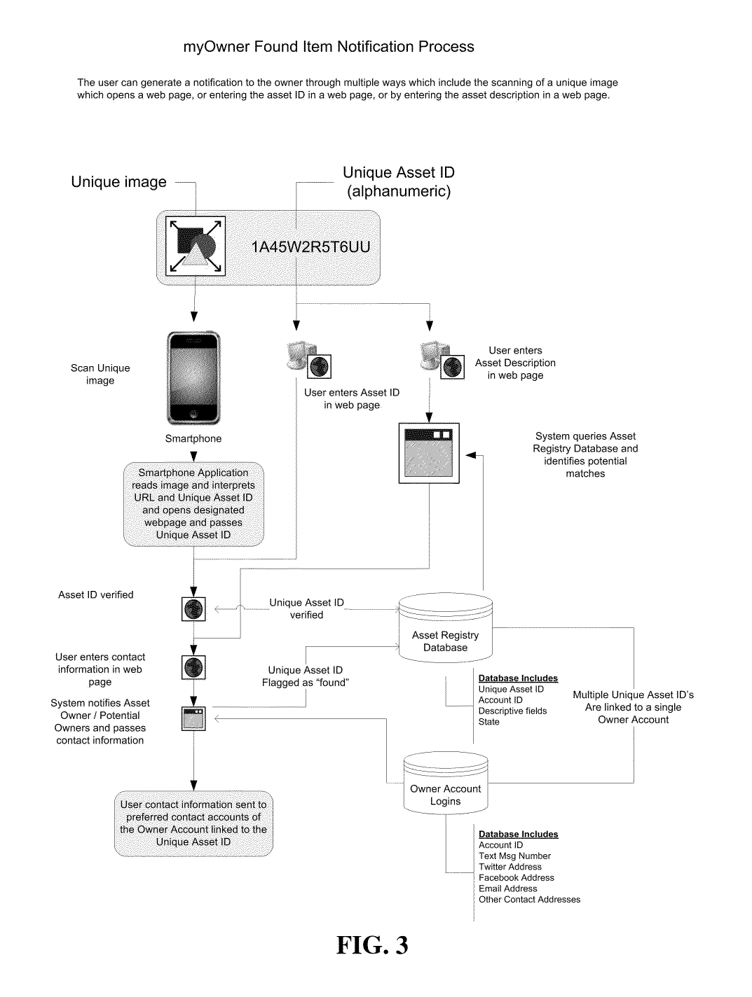

The Unique Alphanumeric Asset Identification Strings 10 may be communicated to the server either by direct entry into an Internet Accessing Device 70 into the Notification Service 40 HTML Internet Page 44; or the Unique Image 20 may be scanned by a scanner or a camera attached to a mobile device which contains an application which can translate the Unique Image into a URL 24 and a Unique Alphanumeric Asset Identification String 10 which are communicated to the Notification Service as described in FIG. 3.

The Notification Service 40 will verify the validity of the Unique Alphanumeric Asset Identification String 10 and then provide the user of the Internet Accessing Device 70 with a form which requests contact information from the User by way of a Message Field 45 and a Finder Contact Field 46 as described in FIG. 3.

Upon submission by the User, the Notification Service 40 will lookup in the Registry 30 the Registered User ID 60 which is associated with the Unique Alphanumeric Asset Identification String 10 and subsequently look up the contact information associated with the Registered User ID as described in FIG. 3.

The Notification Service 40 will subsequently generate a message through multiple communication Systems 43 which includes the Message Field 45 and the Finder Contact Field 46.

### K. Alternative Embodiments of Invention

1st Alternative Variation:

Alternatively, the Internet Accessing Device 70 may connect to the Server 80 through a public or private network.

2nd Alternative Variation:

Alternatively, the User may elect to verify the identity of the item by entering the Model Number into the Model Number Field 34 and the Serial Number into the Serial Number Field 35, where the Notification Service will lookup the Serial Number and Model Number from the Registry 30 and identify the Unique Alphanumeric Asset Identification String 10 and then follow the.

Upon submission by the User, the Notification Service 40 will lookup in the Registry 30 the Registered User ID 60 which is associated with the Unique Alphanumeric Asset Identification String 10 and subsequently look up the contact information associated with the Registered User ID as described in FIG. 3.

The Notification Service 40 will subsequently generate a message through multiple communications Systems 43 which includes the Message Field 45 and the Finder Contact Field 46.

Alternatively, the User may elect to verify the identity of the item by entering descriptive information into the Other Descriptive Data Fields 36 which are then used to lookup all of the Unique Alphanumeric Asset Identification Strings 10 that are associated with matching descriptive information.

Upon submission by the User, the Notification Service 40 will lookup in the Registry 30 the Registered User IDs 60 which are associated with the Unique Alphanumeric Asset Identification Strings 10 and subsequently look up the contact information associated with the Registered User Ids 60 as described in FIG. 3.

The Notification Service 40 will subsequently generate a message through multiple communication Systems 43 which includes the Message Field 45 and the Finder Contact Field 46.

### L. Operation of Preferred Embodiment

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention in which all terms are meant in their broadest, reasonable sense unless otherwise indicated. Any headings utilized within the description are for convenience only and have no legal or limiting effect.

### INDEX OF ELEMENTS

10: Unique Alphanumeric Asset Identification Strings
11: Alpha Numeric Character String
20: Unique Image
21: Color
22: Pixels
23: Shapes
24: Url
30: Registry
31: Unique Alphanumeric Asset Identification String Database
32: Unique Alphanumeric Asset Identification String Field
33: Registered User Id Field
34: Model Number Field
35: Serial Number Field
36: Other Descriptive Data Fields
40: Notification Service
41: Registration Database
42: Registry
43: Communication System
44: Html Internet Page
45: Message Field
46: Finder Contact Field
50: Identification Label
51: Substrate
52: Adhesive
53: Clear Wear Layer
54: Ink
57: Url
60: Registered User Id
61: Unique Character String
70: Internet Accessing Device
71: Internet Device
72: Internet Connection
80: Server
81: Server Hardware
82: Network Connection
83: Server Operating System
84: Server Applications

What is claimed is:

1. An asset identification and messaging system comprising:
a tag bearing a unique identification, for attaching to an asset;
a user account stored in a database, containing user contact information and data related to the asset associated with the tag;
whereby when an asset is found, the finder may use the tag to indicate the asset has been found.

2. The asset identification and messaging system of claim 1 wherein the unique identification is encoded in a manner selected from the group consisting Bar Code, QR code and Microsoft TAG code.

3. The asset identification and messaging system of claim 2 wherein the database is stored on a server connected to the internet, and the database is encrypted.

4. The asset identification and messaging system of claim 3 wherein the finder indicates the asset has been found by using a smartphone application to image the tag, which communicates the unique identification to the server.

5. The asset identification and messaging system of claim 4 wherein the finder is prompted for contact information, which is transmitted to the user, using the user contact information stored in the database.

6. The asset identification and messaging system of claim 3 wherein the finder indicates the asset has been found by entering the unique identification at a website address indicated on the tag.

7. The asset identification and messaging system of claim 6 wherein the finder is prompted for contact information, which is transmitted to the user, using the user contact information stored in the database.

8. The asset identification and messaging system of claim 1 wherein the tag contains the unique identification in both a machine and human readable form, along with a website address to report found assets to.

9. The asset identification and messaging system of claim 8 wherein the tags are sold in packets containing a plurality of tags, each bearing a unique identification number.

10. A method of asset identification and asset recovery comprising the steps of:
attaching a tag bearing a unique identification to an asset;
entering the unique identification number into a database containing a user account, the user account having user contact information, and entering data related to the asset associated with the tag into the database;
using the tag to indicate that a lost asset has been found.

11. The method of asset identification and asset recovery of claim 10 wherein the unique identification is encoded in a manner selected from the group consisting Bar Code, QR code and Microsoft TAG code.

12. The method of asset identification and asset recovery of claim 11 wherein the database is stored on a server connected to the internet, and the database is encrypted.

13. The method of asset identification and asset recovery of claim 12 wherein the finder indicates the asset has been found by using a smartphone application to image the tag, which communicates the unique identification to the server.

14. The method of asset identification and asset recovery of claim 13 wherein the finder is prompted for contact information, which is transmitted to the user, using the user contact information stored in the database.

15. The method of asset identification and asset recovery of claim 12 wherein the finder indicates the asset has been found by entering the unique identification at a website address indicated on the tag.

16. The method of asset identification and asset recovery of claim 15 wherein the finder is prompted for contact information, which is transmitted to the user, using the user contact information stored in the database.

17. The method of asset identification and asset recovery of claim 10 wherein the tag contains the unique identification in both a machine and human readable form, along with a website address to report found assets to.

18. The method of asset identification and asset recovery of claim 17 wherein the tags are sold in packets containing a plurality of tags, each bearing a unique identification number.
